(19) United States
(12) Patent Application Publication
(10) Pub. No.: US 2003/0101103 A1
(43) Pub. Date: May 29, 2003

(54) Commodity selling system, commodity selling method, and in-vehicle device in commodity selling system

(75) Inventor: Yoshikazu Otsubo, Hirakata City (JP)

Correspondence Address: ARMSTRONG,WESTERMAN & HATTORI, LLP, 1725 K STREET, NW, SUITE 1000, WASHINGTON, DC, 20006, US

(73) Assignee: Sanyo Electric Co., Ltd., Osaka (JP)

(21) Appl. No.: 10/303,741

(22) Filed: Nov. 26, 2002

(30) Foreign Application Priority Data
Nov. 28, 2001 (JP) 2001-363095

(51) Int. Cl. G06F 17/60

(52) U.S. Cl. 705/26; 705/1; 701/201

(57) ABSTRACT

A management server sends to a broadcasting station commodity information including the name of a commodity, the price of the commodity, and a communication address of the management server in commodity and shop information stored in a commodity and shop information management table, a broadcasting station receives the commodity information transmitted from the management server, multiplexes the commodity information on an audio signal, and sends out the commodity information multiplexed on the audio signal, and an in-vehicle device receives data multiplex broadcasting sent out from the broadcasting station, extracts the commodity information from the received data multiple broadcasting, displays on a display unit the name of the commodity and the price thereof in the extracted commodity information, and transmits, when the commodity which is desired to be purchased by a user is designated on the basis of the name of the commodity and the price thereof which are displayed on the display unit, order information including the name of the designated commodity, etc. to the management server on the basis of the name of the commodity and the price thereof which are displayed on the display unit.

### BACKGROUND OF THE INVENTION

1. Field of the Invention

The present invention relates to a commodity selling system making it possible to purchase a commodity from a moving vehicle, a commodity selling method, and an in-vehicle device in the commodity selling system.

2. Description of the Prior Art

In a case where a user is moving in a moving vehicle, when the user purchases a commodity in an unfamiliar place, it is difficult to search for an object shop. As a measure for this, there is a technique so adapted as to store shop information in map information related to a navigation device, and guide, when a shop included in the map information is designated by a user, a path to the designated shop.

Furthermore, a technique so adapted as to receive and display, when a shop included in map information is designated, commodity information through communication means from the designated shop, cause a user to select a commodity to be ordered, and transmit order information produced on the basis of the selected contents to the designated shop through the communication means has also already been developed (see JP-A-10-339341).

In the conventional method, however, a shop from which a commodity can be purchased is limited to the shop previously stored in the map information related to the navigation device. The information are fixed because they are provided by a CD-ROM (Compact Disc Read-Only Memory) and a DVD (Digital Versatile Disc) for the navigation device. Therefore, the conventional method cannot cope with the opening or closing of the newest shop and an event held on a non-scheduled basis.

### SUMMARY OF THE INVENTION

An object of the present invention is to provide, in a commodity selling system making it possible for a user to purchase a commodity from a moving vehicle and a commodity selling method, a commodity selling system making it easy for a person who provides commodity and shop information to change and add information related to a shop from which a commodity can be purchased, a commodity selling method, and an in-vehicle device in the commodity selling system.

A commodity selling system according to the present invention comprises a management server, a broadcasting station, and an in-vehicle device carried by a moving vehicle, characterized in that the management server comprises a commodity and shop information management table storing for each commodity commodity and shop information including the name of the commodity, the price (in this specification, the term “price” represents price and cost) of the commodity, and the position or positions of one or a plurality of receiving shops from which the commodity can be received, means for sending to the broadcasting station commodity information including the name of the commodity and the price of the commodity in the commodity and shop information stored in the commodity and shop information management table and a communication address of the management server, means for receiving order information including the name of the commodity, the current position, and a communication address of the in-vehicle device which are transmitted from the in-vehicle device, and means for transmitting, on the basis of the commodity and shop information management table when the order information is received, information related to the position of the receiving shop closest to the current position in the received order information out of information related to the position of the receiving shops corresponding to the name of the commodity in the received order information to the in-vehicle device on the basis of the communication address of the in-vehicle device in the received order information, the broadcasting station comprises means for receiving the commodity information transmitted from the management server, multiplexing the received commodity information on an audio signal, and sending out the commodity information multiplexed on the audio signal, and the in-vehicle device comprises position detection means for detecting the current position, means for receiving data multiplex broadcasting sent out from the broadcasting station and extracting the commodity information from the received data multiplex broadcasting, means for displaying on a display unit the name of the commodity and the price thereof in the extracted commodity information, input means for causing a user to designate the commodity which is desired to be purchased on the basis of the name of the commodity and the price thereof which are displayed on the display unit, means for transmitting, when the commodity which is desired to be purchased by the user is designated, the order information including the name of the designated commodity, the current position detected by the position detection means, and the communication address of the in-vehicle device to the management server on the basis of the communication address of the management server in the extracted commodity information, means for receiving the information related to the position of the receiving shop transmitted from the management server, and means for displaying, when the information related to the position of the receiving shop is received, the received information related to the position of the receiving shop on the display unit.

A commodity selling method according to the present invention is characterized in that a commodity and shop information management table storing for each commodity commodity and shop information including information related to the name of the commodity, information related to the price of the commodity, and information related to the positions of a plurality of receiving shops from which the commodity can be received is stored in a management server, the management server sending to a broadcasting station commodity information including the name of the commodity and the price of the commodity in the commodity and shop information stored in the commodity and shop information management table and a communication address of the management server, the broadcasting station receiving the commodity information transmitted from the management server, multiplexing the commodity information on an audio signal, and sending out the commodity information multiplexed on the audio signal, an in-vehicle device receiving data multiplex broadcasting sent out from the broadcasting station, extracting the commodity information from the received data multiplex broadcasting, displaying on a display unit the name of the commodity and the price thereof in the extracted commodity information, and transmitting, when the commodity which is desired to be purchased by a user is designated on the basis of the name of the commodity and the price thereof which are displayed on the display unit, order information including the name of the designated commodity, the current position of a moving vehicle carrying the in-vehicle device, and a communication address of the in-vehicle device to the management server on the basis of the communication address of the management server in the extracted commodity information, the management server transmitting, when the order information is received, information related to the position of the receiving shop closest to the current position in the received order information out of the information related to the positions of the receiving shops corresponding to the name of the commodity in the received order information on the basis of the commodity and shop information management table to the in-vehicle device on the basis of the communication address of the in-vehicle device in the received order information, and the in-vehicle device displaying, when the information related to the position of the receiving shop is received, the received information related to the position of the receiving shop on the display unit.

In an in-vehicle device used in a commodity selling system comprising a management server, a broadcasting station, and an in-vehicle device carried by a moving vehicle, the management server comprising a commodity and shop information management table storing for each commodity commodity and shop information including the name of the commodity, the price of the commodity, and the position or positions of one or a plurality of receiving shops from which the commodity can be received, means for sending to the broadcasting station commodity information including the name of the commodity and the price of the commodity in the commodity and shop information stored in the commodity and shop information management table and a communication address of the management server, means for receiving order information including the name of the commodity, the current position, and a communication address of the in-vehicle device which are transmitted from the in-vehicle device, and means for transmitting, on the basis of the commodity and shop information management table when the order information is received, information related to the position of the receiving shop closest to the current position in the received order information out of information related to the positions of the receiving shops corresponding to the name of the commodity in the received order information to the in-vehicle device on the basis of the communication address of the in-vehicle device in the received order information, and the broadcasting station comprising means for receiving the commodity information transmitted from the management server, multiplexing the received commodity information on an audio signal, and sending out the commodity information multiplexed on the audio signal, the in-vehicle device in the commodity selling system according to the present invention is characterized by comprising position detection means for detecting the current position, means for receiving data multiplex broadcasting sent out from the broadcasting station and extracting the commodity information from the received data multiplex broadcasting, means for displaying on a display unit the name of the commodity and the price thereof in the extracted commodity information, input means for causing a user to designate the commodity which is desired to be purchased on the basis of the name of the commodity and the price thereof which are displayed on the display unit, means for transmitting, when the commodity which is desired to be purchased by the user is designated, the order information including the name of the designated commodity, the current position detected by the position detection means, and the communication address of the in-vehicle device to the management server on the basis of the communication address of the management server in the extracted commodity information, means for receiving the information related to the position of the receiving shop transmitted from the management server, and means for displaying, when the information related to the position of the receiving shop is received, the received information related to the position of the receiving shop on the display unit.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing the configuration of a commodity selling system;

FIG. 2 is a schematic view showing the contents of a commodity and shop information management table provided in a management server;

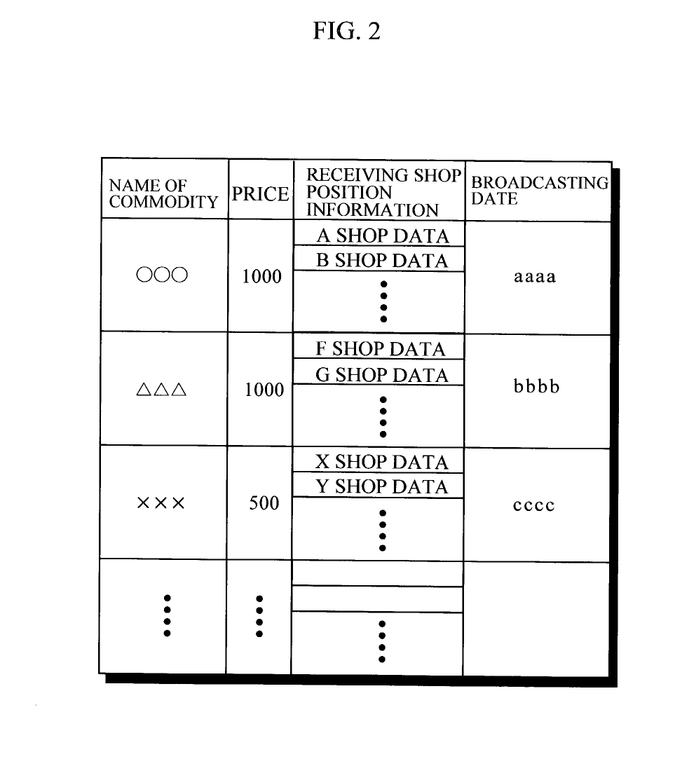

FIG. 3 is a block diagram showing the configuration of an in-vehicle device 3; and

FIG. 4 is a flow chart showing the procedure for processing by a CPU 24 in an in-vehicle device 3.

### DESCRIPTION OF THE PREFERRED EMBODIMENTS

Referring now to the drawings, an embodiment of the present invention will be described.

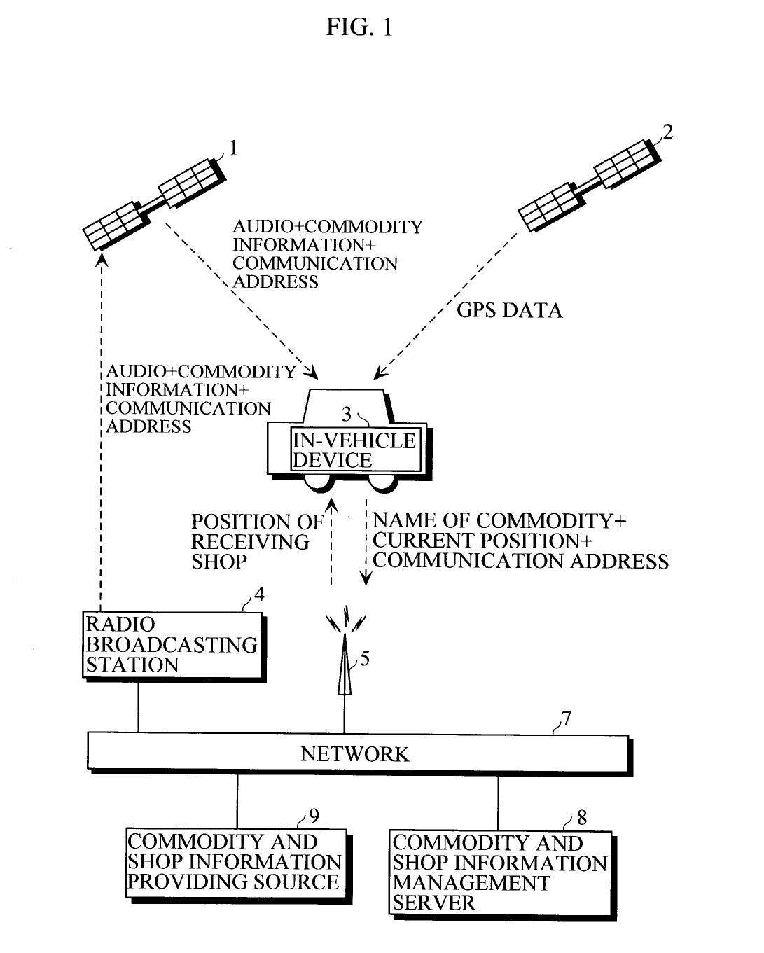

FIG. 1 illustrates the configuration of a commodity selling system.

Commodity and shop information provided from a commodity and shop information providing source 9 such as a commodity manufacturer, a selling company, or an agency therefor is sent to a commodity and shop information management server 8 via a network 7.

The commodity and shop information management server 8 comprises a commodity and shop information management table storing the received commodity and shop information. In this example, the commodity and shop information management table stores for each commodity the name of the commodity, the price of the commodity, information related to the position or positions of one or a plurality of receiving shops from which the commodity can be received, and information related to the broadcasting date.

Specifically, the commodity and shop information comprises the name of the commodity, the price of the commodity, the information related to the position or positions of one or the plurality of receiving shops from which the commodity can be received, and the information related to the broadcasting date. Used as the information related to the position of the receiving shop are data representing the latitude and longitude of the receiving shop, data representing the address of the receiving shop, data representing a guide map to the receiving shop, etc.

The commodity and shop information management server 8 sends, when the current date is the broadcasting date defined by any of the information related to the broadcasting date in the commodity and shop information management table, the name and the price of the corresponding commodity, together with a communication address (a telephone number, an E-mail address, etc.) of the commodity and shop information management server 8, to a radio broadcasting station 4. Information related to two or more commodities may, in some cases, be sent to the radio broadcasting station 4 on the same date.

The radio broadcasting station 4 multiplexes, when it receives from the commodity and shop management server 8 the commodity information comprising the name of the commodity, the price of the commodity, and the communication address of the commodity and shop information management server 8, the received commodity information on music which is a main audio, to broadcast the commodity information multiplexed on the music using a broadcasting satellite 1.

The in-vehicle device 3 carried by a moving vehicle detects the current position utilizing a GPS (Global Positioning System) satellite 2, receives data multiplex broadcasting sent out from the radio broadcasting station 4 through the broadcasting satellite 1, and establishes communication between the in-vehicle device 3 and the commodity and shop information management server 8.

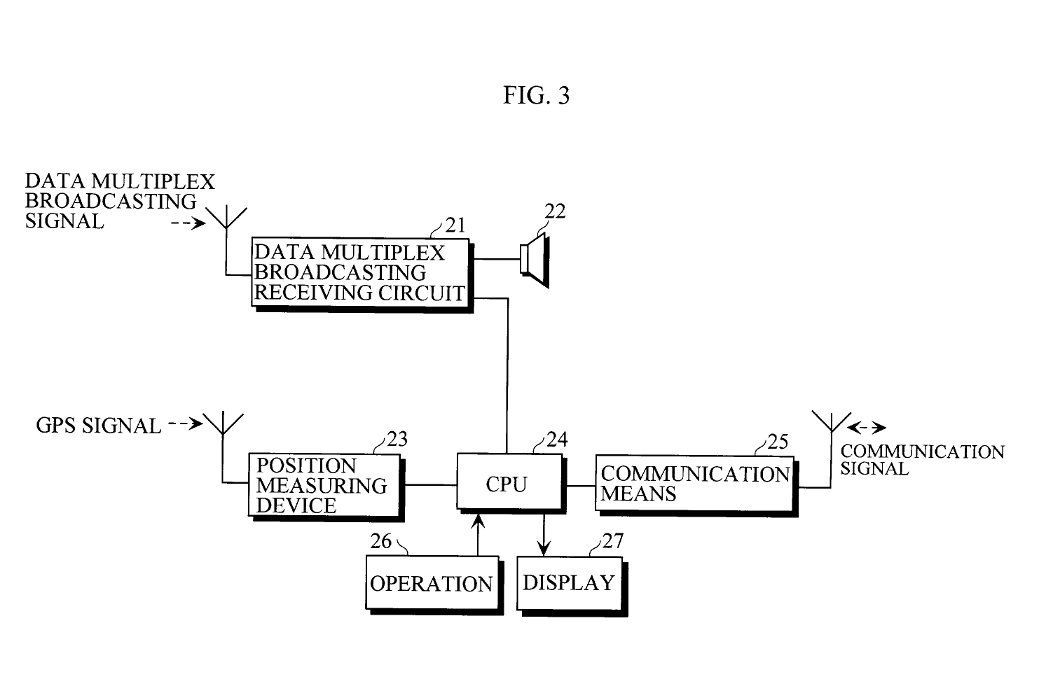

FIG. 3 illustrates the configuration of the in-vehicle device 3.

The data multiplex broadcasting sent out from the radio broadcasting station 4 through the broadcasting satellite 1 is decoded by a data multiplex broadcasting receiving circuit 21. An audio signal which is a main signal out of signals obtained by the decoding is sent to a speaker 22 and is reproduced as an audio, and commodity information is inputted to a CPU 24.

A position measuring device 23 receives a GPS signal from the GPS satellite 2, to detect the current position. The current position detected by the position measuring device 23 is inputted to the CPU 24.

An operation unit 26, a display unit 27, and communication means 25 are connected to the CPU 24. In this example, a cellular phone is used as the communication means 2.

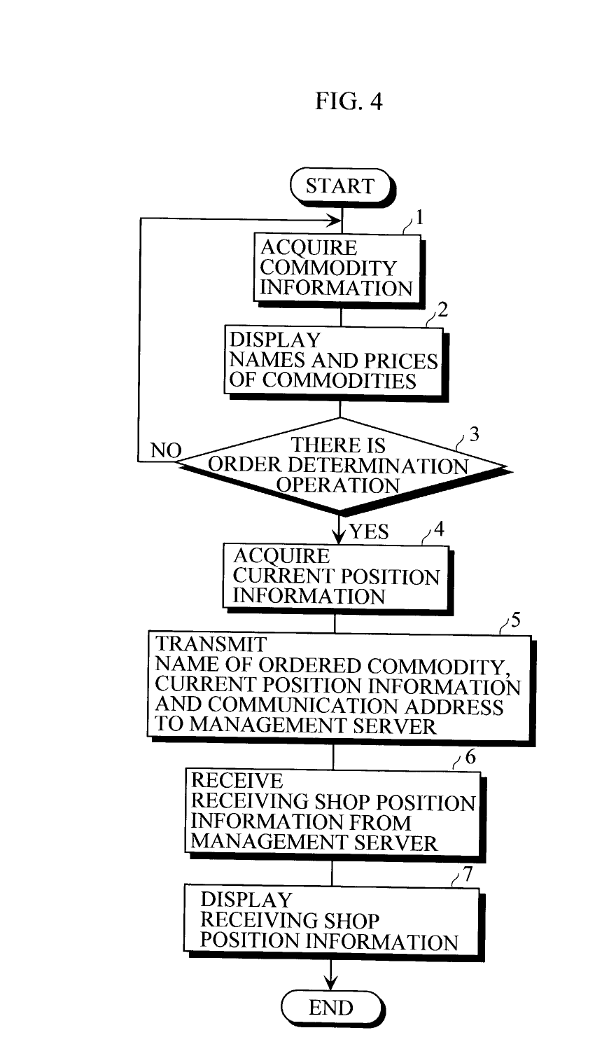

FIG. 4 shows the procedure for processing by the CPU 24.

When commodity information is acquired from the data multiplex broadcasting receiving circuit 21 (step 1), the names and the prices of commodities in the commodity information are displayed on the display unit 27 (step 2).

A user performs, when the commodity which is desired to be purchased exists on the basis of the names and the prices of the commodities displayed on the display unit 27, an order determination operation for purchasing the commodity using the operation unit 26. When there is no order determination operation within a predetermined time period, the program is returned to the step 1.

When the order determination operation is performed within the predetermined time period (step 3), information related to the current position is acquired from the position measuring device 23 (step 4). Order information comprising information related to the name of the commodity ordered by the user, information related to the current position acquired form the position measuring device 23, and a communication address of the in-vehicle device 3 (a telephone number, an E-mail address, etc. of a cellular phone terminal) is transmitted using the communication means 25 to a destination of transmission defined by a communication address in the commodity information acquired in the foregoing step 1 (step 5).

The order information transmitted from the communication means 25 is sent to the commodity and shop information management server 8 via communication equipment 5 (see FIG. 1) and the network 7. In the commodity and shop information management server 8, on the basis of the name of the commodity and the current position in the received order information and the commodity and shop information management table, information related to the position of the receiving shop closest to the received current position out of information related to the positions of the receiving shops corresponding to the received commodity name is selected, and the selected receiving shop position information is transmitted to the destination of transmission defined by the communication address in the received order information.

The receiving shop position information transmitted from the commodity and shop information management server 8 is received by the communication means 25 in the in-vehicle device 3 via the network 7 and the communication equipment 5. The receiving shop position information received by the communication means 25 is inputted to the CPU 24.

When the receiving shop position information is acquired (step 6), the position of the receiving shop is displayed on the display unit 27 on the basis of the acquired receiving shop position information (step 7).

The user drives, on the basis of the position of the receiving shop displayed on the display unit 27, the vehicle to the receiving shop to receive the ordered commodity.

Although in the above-mentioned embodiment, the position measuring device 23 utilizing the GPS function in order to detect the current position of the in-vehicle device 3, other position measuring devices may be used. For example, a position measuring device for detecting as the current position the position of a base station used when a cellular phone used as communication means establishes communication may be used.

According to the above-mentioned embodiment, the commodity and shop information providing source 9 may register, when it is desired to change and add a commodity to be sold, the price thereof, a receiving shop from which the commodity is received, etc., commodity and shop information after the change and the addition in the commodity and shop information management server 8. Therefore, it becomes easy to change and add the commodity to be sold, the price thereof, the receiving shop from which the commodity is received, etc.

Although the present invention has been described and illustrated in detail, it is clearly understood that the same is by way of illustration and example only and is not to be taken by way of limitation, the spirit and scope of the present invention being limited only by the terms of the appended claims.

What is claimed

1. A commodity selling system comprising a management server, a broadcasting station, and an in-vehicle device carried by a moving vehicle, wherein
the management server comprises
a commodity and shop information management table storing for each commodity commodity and shop information including the name of the commodity, the price of the commodity, and the position or positions of one or a plurality of receiving shops from which the commodity can be received,
means for sending to the broadcasting station commodity information including the name of the commodity and the price of the commodity in the commodity and shop information stored in the commodity and shop information management table and a communication address of the management server,
means for receiving order information including the name of the commodity, the current position, and a communication address of the in-vehicle device which are transmitted from the in-vehicle device, and
means for transmitting, on the basis of the commodity and shop information management table when the order information is received, information related to the position of the receiving shop closest to the current position in the received order information out of information related to the positions of the receiving shops corresponding to the name of the commodity in the received order information to the in-vehicle device on the basis of the communication address of the in-vehicle device in the received order information,
the broadcasting station comprises
means for receiving the commodity information transmitted from the management server, multiplexing the received commodity information on an audio signal, and sending out the commodity information multiplexed on the audio signal, and
the in-vehicle device comprises
position detection means for detecting the current position,
means for receiving data multiplex broadcasting sent out from the broadcasting station and extracting the commodity information from the received data multiplex broadcasting,
means for displaying on a display unit the name of the commodity and the price thereof in the extracted commodity information,
input means for causing a user to designate the commodity which is desired to be purchased on the basis of the name of the commodity and the price thereof which are displayed on the display unit,
means for transmitting, when the commodity which is desired to be purchased by the user is designated, the order information including the name of the designated commodity, the current position detected by the position detection means, and the communication address of the in-vehicle device to the management server on the basis of the communication address of the management server in the extracted commodity information,
means for receiving the information related to the position of the receiving shop transmitted from the management server, and
means for displaying, when the information related to the position of the receiving shop is received, the received information related to the position of the receiving shop on the display unit.

2. A commodity selling method, wherein
a commodity and shop information management table storing for each commodity commodity and shop information including information related to the name of the commodity, information related to the price of the commodity, and information related to the positions of a plurality of receiving shops from which the commodity can be received is stored in a management server,
the management server sending to a broadcasting station commodity information including the name of the commodity and the price of the commodity in the commodity and shop information stored in the commodity and shop information management table and a communication address of the management server,
the broadcasting station receiving the commodity information transmitted from the management server, multiplexing the commodity information on an audio signal, and sending out the commodity information multiplexed on the audio signal,
an in-vehicle device receiving data multiplex broadcasting sent out from the broadcasting station, extracting the commodity information from the received data multiplex broadcasting, displaying on a display unit the name of the commodity and the price thereof in the extracted commodity information, and transmitting, when the commodity which is desired to be purchased by a user is designated on the basis of the name of the commodity and the price thereof which are displayed on the display unit, order information including the name of the designated commodity, the current position of a moving vehicle carrying the in-vehicle device, and a communication address of the in-vehicle device to the management server on the basis of the communication address of the management server in the extracted commodity information,
the management server transmitting, when the order information is received, information related to the position of the receiving shop closest to the current position in the received order information out of the information related to the positions of the receiving shops corresponding to the name of the commodity in the received order information on the basis of the commodity and shop information management table to the in-vehicle device on the basis of the communication address of the in-vehicle device in the received order information, and
the in-vehicle device displaying, when the information related to the position of the receiving shop is received, the received information related to the position of the receiving shop on the display unit.

3. In an in-vehicle device used in a commodity selling system comprising a management server, a broadcasting station, and an in-vehicle device carried by a moving vehicle,
the management server comprising
a commodity and shop information management table storing for each commodity commodity and shop information including the name of the commodity, the price of the commodity, and the position or positions of one or a plurality of receiving shops from which the commodity can be received,
means for sending to the broadcasting station commodity information including the name of the commodity and the price of the commodity in the commodity and shop information stored in the commodity and shop information management table and a communication address of the management server,
means for receiving order information including the name of the commodity, the current position, and a communication address of the in-vehicle device which are transmitted from the in-vehicle device, and
means for transmitting, on the basis of the commodity and shop information management table when the order information is received, information related to the position of the receiving shop closest to the current position in the received order information out of information related to the positions of the receiving shops corresponding to the name of the commodity in the received order information to the in-vehicle device on the basis of the communication address of the in-vehicle device in the received order information, and
the broadcasting station comprising
means for receiving the commodity information transmitted from the management server, multiplexing the received commodity information on an audio signal, and sending out the commodity information multiplexed on the audio signal,
the in-vehicle device in the commodity selling system comprising
position detection means for detecting the current position,
means for receiving data multiplex broadcasting sent out from the broadcasting station and extracting the commodity information from the received data multiplex broadcasting,
means for displaying on a display unit the name of the commodity and the price thereof in the extracted commodity information,
input means for causing a user to designate the commodity which is desired to be purchased on the basis of the name of the commodity and the price thereof which are displayed on the display unit,
means for transmitting, when the commodity which is desired to be purchased by the user is designated, the order information including the name of the designated commodity, the current position detected by the position detection means, and the communication address of the in-vehicle device to the management server on the basis of the communication address of the management server in the extracted commodity information,
means for receiving the information related to the position of the receiving shop transmitted from the management server, and
means for displaying, when the information related to the position of the receiving shop is received, the received information related to the position of the receiving shop on the display unit.
